(19) United States
(12) Patent Application Publication
(10) Pub. No.: US 2012/0260853 A1
(43) Pub. Date: Oct. 18, 2012

(54) CONFORMABLE CAPILLARY COATING DEVICES FOR A SUBSTRATE WITH VARIABLE HEIGHTS

(75) Inventors: An-Bang Wang, Taipei City (TW); Tzu-Yao Lin, New Taipei City (TW); Han-Ren Liu, Taipei City (TW); Ying-Chi Hsu, Taipei City (TW); Tong-Chee Hsu, Taipei City (TW)

(73) Assignee: NATION TAIWAN UNIVERSITY, Taipei (TW)

(21) Appl. No.: 13/535,313

(22) Filed: Jun. 27, 2012

Related U.S. Application Data
(63) Continuation-in-part of application No. 12/398,962, filed on Mar. 5, 2009, now Pat. No. 8,257,794.

(30) Foreign Application Priority Data
Aug. 21, 2008 (TW) TW097131892

(51) Int. Cl. B05C 5/02

(52) U.S. Cl. 118/323; 118/300

(57) ABSTRACT

A discontinuous capillary coating device is disclosed. At least one capillary tube is filled with a coating material. At least one flexible member is disposed in the capillary tube and is immersed in the coating material. The flexible member extends to the exterior of the capillary tube, guiding and outputting the coating material. At least one coating substrate receives a liquid coating film from the coating material via the flexible member. At least one capillary tube holder holds the capillary tube, guiding movement of the capillary tube. At least one traversing mechanism drives the capillary tube holder or coating substrate to move.

### CROSS REFERENCE TO RELATED APPLICATIONS

The present application is a continuation-in-part of and claims priority from U.S. patent application Ser. No. 12/398,962, filed Mar. 5, 2009, the content of which is hereby incorporated by reference in its entirety.

This Application claims priority of Taiwan Patent Application No. 097131892, filed on Aug. 21, 2008, the entirety of which is incorporated by reference herein.

### BACKGROUND OF THE INVENTION

1. Field of the Invention

The invention relates to capillary coating devices, and more particularly to capillary coating devices for manufacturing color filters of liquid crystal displays, color units of fluorescent layers of plasma displays, biomedical products, flexible electronic members, or cells on substrates with uneven surfaces.

2. Description of the Related Art

A flat panel display has been developed to replace a cathode-ray tube display. The flat panel display, such as a liquid crystal display, comprises a backlight source, a polarizer, a glass substrate, a liquid crystal panel, a thin-film transistor (TFT), and a color filter (CF). Specifically, the color filter plays an important role in exhibition of colored characteristics and contrast of the liquid crystal display.

The color filter of the liquid crystal display and a color unit of a fluorescent layer of a plasma display are critical components for transforming black-and-white images into colored images. For the color filter of the liquid crystal display, multiple red, green, and blue pixels are arranged on the glass substrate and every three of the pixels correspond to a pixel on the liquid crystal display. After white light passes through the red, green, and blue pixels, three primary colors, red (R), green (G), and blue (B) colors, are generated. By a grayscale effect generated by liquid crystal molecules, the three primary colors mix with each other to form diverse colors. Currently, the color filter may be manufactured using five methods, i.e. exposure development, stamping, ink-jet printing, stripe coating, and discontinuous micro-patch coating methods. As to the exposure development method, a pattern is defined by repeated coating of a flat liquid film and exposure/development steps. The exposure development method may be divided into many sub-methods including dyeing, pigment dispersion, electro deposition, etc. As to the stamping method, a stamp defines a pattern and pigments are imprinted on a substrate. As to the ink-jet printing method, a nozzle spouts tiny drops over a substrate, forming micro-patch patterns. As to the stripe coating method, various pigments are coated on a black matrix of a color filter in a stripe shape. As to the discontinuous micro-patch coating method, a discontinuously supplied fluid directly defines a micro-patch pattern.

In the aforementioned exposure development methods, coating of the flat liquid film must be provided in advance. The coating process comprises spin coating, extrusion spin coating, and slot patch coating process. For the spin coating process, such as that disclosed in U.S. Pat. No. 4,451,507, utilization of raw materials is not thorough. However, for the extrusion spin coating process (as disclosed by U.S. Pat. No. 6,191,053) and slot patch coating process (as disclosed by U.S. Pat. No. 4,938,994), the utilization of the raw materials can be enhanced. As to the sub-methods of dyeing, pigment dispersion, and electro deposition, raw materials for coating the liquid film are different, thereby causing differences in manufacturing processes.

As to the dyeing method, as disclosed in U.S. Pat. No. 4,744,635, a transparent and organic sensitive material serves as an absorptive layer and a pattern is processed by a litho/etching technique. The absorptive layer is then immersed in a dye solution to be dyed. To obtain the pattern with red (R), green (G), and blue (B) colors, the aforementioned process must be performed by triple coating, exposure, dyeing, roast, and anti-dyeing steps. Accordingly, as the dyeing method provides complex steps and requires expensive instruments or equipment and the heat-resistant and light-resistant properties of dyes are poor, the dyeing method is limited to manufacturing of small liquid crystal display panels and cathode-ray tubes.

The pigment dispersion method, as disclosed in U.S. Pat. No. 5,085,973 and U.S. Pat. No. 4,786,148, is commonly used to manufacture the color filters. The pigment dispersion method employs sensitive and heat-hardened pigments and comprises the following steps: coating a coloring material on a glass substrate; performing exposure, development, and roast operations to form a monochromatic patch; and repeatedly performing exposure, development, and roast operations to form R, G, and B pixels. Nevertheless, the pigment dispersion method provides complex steps and requires expensive equipment, utility rate of the coloring material is low, and variability of the pixels and pattern is poor. Accordingly, the pigment dispersion method cannot be applied to manufacturing of large panels and conform to low-price demands.

As to the electro deposition method, as disclosed in U.S. Pat. No. 4,522,691, a transparent and patterned conductive film is formed on a glass substrate and a film formed of a coloring material is formed on the transparent and patterned conductive film using an electrophoresis technique. After the aforementioned process is repeated three times, a pattern with R, G, and B colors can be obtained. Nevertheless, as the electro deposition method requires many processing parameters, productivity cannot be easily controlled. Specifically, because of the transparent and patterned conductive film, light permeability and definition of the pattern is insufficient. Additionally, arrangement of the pattern is limited, such that a color filter with a complicated pattern cannot be produced.

Regarding the exposure development method, as the pattern cannot be directly defined during coating and excessive raw materials must be removed by an exposure/development step, utility rate of the raw materials is less than one-third. Thus, the exposure development method cannot be applied to mass production and conform to reduction of manufacturing costs.

As to the stamping method, as disclosed in Taiwan Patent No. 535010, a stamp or a printing board with a micro-structural pattern is stained with a dye and is stamped on a substrate, forming the micro-structural pattern thereon. The micro-structural pattern is then roasted. After the aforementioned process is repeated three times, a pattern with R, G, and B colors can be obtained. Although the stamping method can enhance the utility rate of the raw materials and reduce the manufacturing costs, variability of the pattern is still insufficient. Accordingly, arrangement of pixels cannot be randomly changed.

As to the ink-jet printing method, as disclosed in Taiwan Patent No. 512242, a pattern can be determined by directly controlling the position of nozzles. The ink-jet printing method comprises the following steps: coating an absorptive layer on a glass substrate, securing ink drops to the glass substrate; and spouting red, green, and blue ink over the glass substrate with the nozzles, forming a required pattern. By using the ink-jet printing method, utility rate of raw materials and variability of the pattern are promoted. Each ink drop must be accurately spouted over a micrometer-size area or an area with a smaller size. Nevertheless, as airflows easily interfere with flight of the ink drops, the ink drops are often spouted over other patches, contaminating the other patches. Thus, a machine required for spouting the ink drops must provide high positioning precision and the moving speed thereof is limited. Moreover, each nozzle can spout only one ink drop at a time, such that the productivity cannot be enhanced. To solve the aforementioned problem, the number of the nozzles must be increased, thereby causing increased manufacturing costs. When the ink-spouting operation is performed, all the nozzles must be maintained in a good condition and must not be obstructed. When the ink-jet printing method is applied to the manufacturing of the large panels, the size of the machine required for spouting the ink drops is enlarged and mobility and uniformity of the machine must be maintained.

The stripe coating method is an improved slot coating method. As to the stripe coating method, various pigments are coated on a black matrix in the form of stripes, forming R, G, and B stripes. For example, U.S. Pat. No. 6,423,140 discloses a slot coating method using multiple guiding plates for a coating mold. Stripes composed of three fluids can be obtained using the slot coating method. Specifically, the three fluids are input to multiple channels of the coating mold via three inlets thereof. The three fluids gather on one side through the guiding plates, forming the stripes. Nevertheless, the coating mold must be provided with high precision. Additionally, flow of the three fluids is not easily controlled, thereby causing mixing therebetween. Moreover, Taiwan Patent Publication No. 200702743 discloses a stripe coating method and mechanism for manufacturing the color filter. The stripe coating mechanism comprises a coating mold with multiple tiny outlets arranged in a single row. A fluid flows into the coating mold. By relatively moving a coating substrate, multiple parallel monochromatic stripes are coated on the color filter. Nevertheless, as the coating mold is provided with various channels for generating the stripes, resistance caused by the fluid is significantly high. Thus, a fluid supply source must be provided in the stripe coating mechanism to transport the fluid. Moreover, as the profile of the channels in the coating mold is fixed, the gaps between the coated parallel stripes are fixed, resulting in low variability of a pattern.

Taiwan Patent Publication No. 200824799 and U.S. Patent Publication No. 20080145537 disclose a discontinuous micro-patch coating device. Continuous coating operations and a discontinuously supplied fluid define a micro-patch pattern. The discontinuously supplied fluid is a micro multi-phase fluid composed of multiple primary fluids and a secondary fluid. The coating operation is performed by the primary fluids. The secondary fluid cuts off the primary fluids and may comprise a gas. By controlling the volume and length of the primary and secondary fluids, the micro-patch pattern can be controlled. Nevertheless, as the aforementioned coating operation requires a plurality of fluid supply sources and the flow of the fluids must be precisely controlled, overall control of the coating operation is complex and equipment costs are relatively high.

Hence, there is a need for a capillary coating device, solving the aforementioned problems.

### BRIEF SUMMARY OF THE INVENTION

A detailed description is given in the following embodiments with reference to the accompanying drawings.

An exemplary embodiment of the invention provides a discontinuous capillary coating device comprising at least one capillary tube, at least one flexible member, at least one coating substrate, at least one capillary tube holder, and at least one traversing mechanism. The capillary tube is filled with a coating material. The flexible member is disposed in the capillary tube and is immersed in the coating material. The flexible member extends to the exterior of the capillary tube, guiding and outputting the coating material. It makes contact between the device and substrate possible. The coating substrate receives a liquid coating film from the coating material via the flexible member. The capillary tube holder holds the capillary tube, guiding movement of the capillary tube. A feedback control device is used to maintain contact with a surface to be coated, improving conformality. An example would be a constant force (e.g. a spring) applicator. The traversing mechanism drives the capillary tube holder or coating substrate to move.

Another exemplary embodiment of the invention provides a continuous capillary coating device comprising at least one capillary tube, at least one fluid reservoir, at least one flexible member, at least one coating substrate, at least one capillary tube holder, and at least one traversing mechanism. The fluid reservoir provides a coating material to the capillary tube. The flexible member is disposed in the capillary tube and is immersed in the coating material. The flexible member extends to the exterior of the capillary tube, guiding and outputting the coating material. The coating substrate receives a liquid coating film from the coating material via the flexible member. The capillary tube holder holds the capillary tube, guiding movement of the capillary tube. The traversing mechanism drives the capillary tube holder or coating substrate to move.

According to the aforementioned embodiments, the capillary tube comprises a tapered outlet, and the flexible member extends to the exterior of the capillary tube through the tapered outlet.

According to the aforementioned embodiments, the tapered outlet comprises a polished flat opening.

According to the aforementioned embodiments, the coating material is capable of wetting the coating substrate.

According to the aforementioned embodiments, unidirectional latitude is provided between the capillary tube and the capillary tube holder.

According to the aforementioned embodiments, a barricade is disposed on the capillary tube or capillary tube holder, restraining the ultimate moving position of the capillary tube.

According to the aforementioned embodiments, the flexible member comprises a solid material, a hollow material, or a porous material.

According to the aforementioned embodiments, the solid material comprises a metal wire, a plastic wire, fiber glass, fiber, fur, or feather.

According to the aforementioned embodiments, the hollow material comprises a plastic tube.

According to the aforementioned embodiments, the porous material comprises open cell foam (as in a sponge) or fibrous network (as in a marking pen).

### BRIEF DESCRIPTION OF THE DRAWINGS

The invention can be more fully understood by reading the subsequent detailed description and examples with references made to the accompanying drawings, wherein:

FIGS. 1A to 1F are schematic plane views showing a discontinuous capillary coating operation of the invention;

FIGS. 2A to 2C are schematic plane views showing a discontinuous capillary coating device of the invention and a discontinuous capillary coating operation thereof; and

FIGS. 3A to 3D are schematic plane views showing a continuous capillary coating device of the invention and a continuous capillary coating operation thereof.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

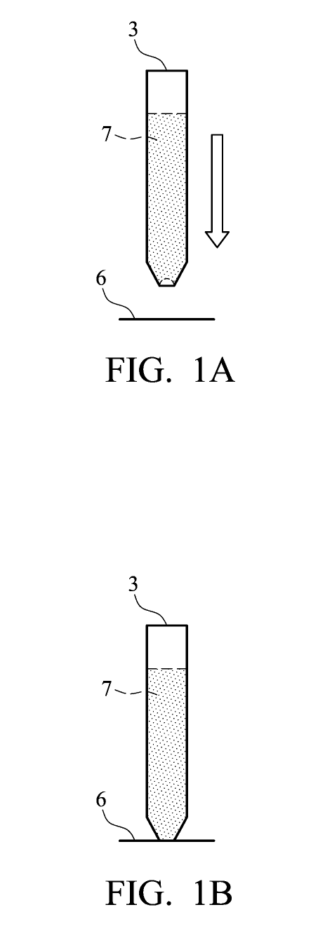

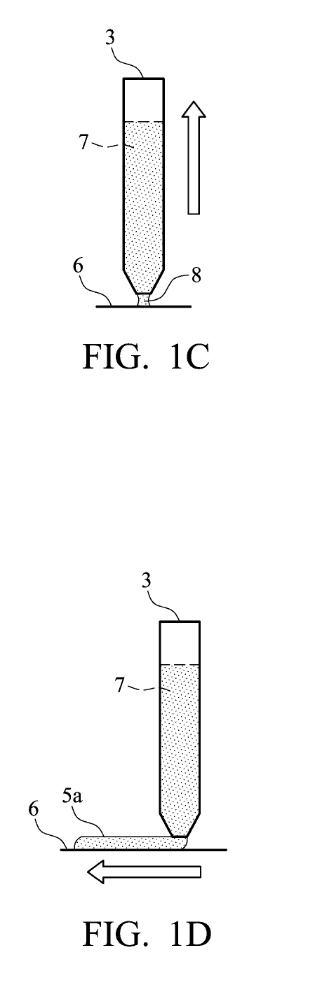

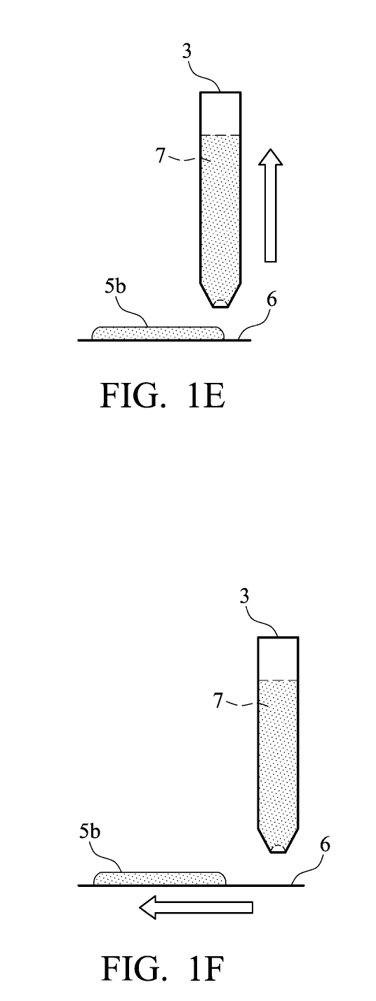

FIGS. 1A to 1F are schematic plane views showing a discontinuous capillary coating operation. As shown in FIG. 1A, a capillary tube 3 filled with a coating material 7 is moved downward. As shown in FIG. 1B, the capillary tube 3 contacts a coating substrate 6, enabling the coating material 7 to adhere to the coating substrate 6. As shown in FIG. 1C, the capillary tube 3 moves upward to a specific position, connecting the capillary tube 3 to the coating substrate 6 through a liquid bridge 8. As shown in FIG. 1D, the capillary tube 3 is moved with respect to and parallel to the coating substrate 6, coating the coating material 7 onto the coating substrate 6, and further forming a liquid film 5a. As shown in FIG. 1E, the capillary tube 3 is moved upward, cutting off the liquid bridge 8 between the coating material 7 and the coating substrate 6, and thus forming a micro-patch 5b. As shown in FIG. 1F, the capillary tube 3 is again moved with respect to the coating substrate 6, producing the next coated patch. In the aforementioned coating process, the length of the micro-patch 5b and the distance between the micro-patches 5b can be adjusted by adjusting the coating operation.

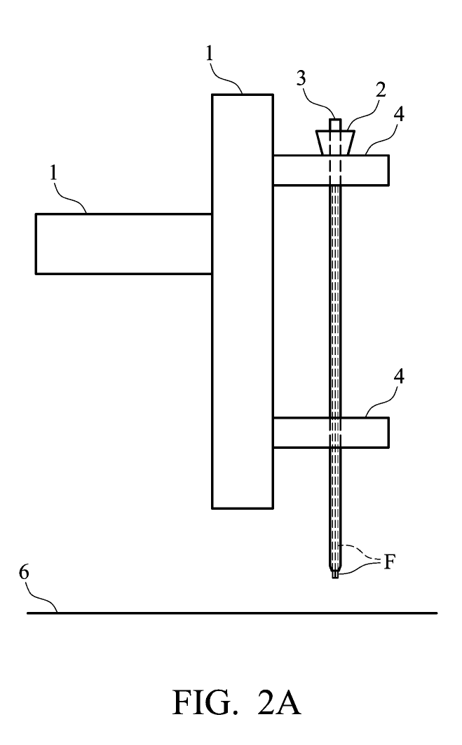

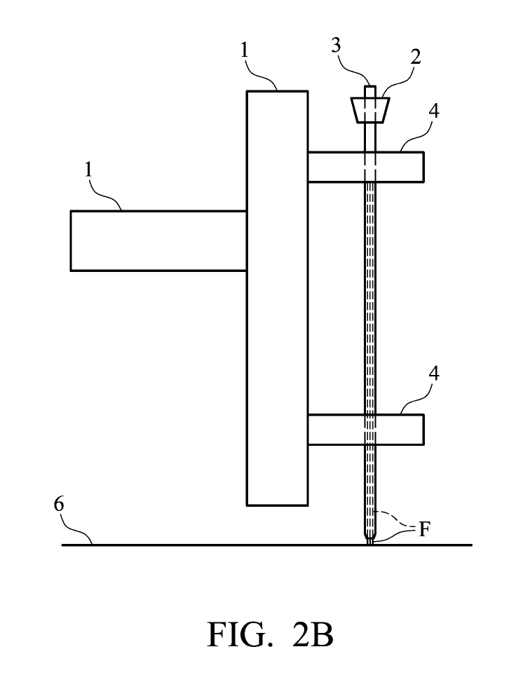

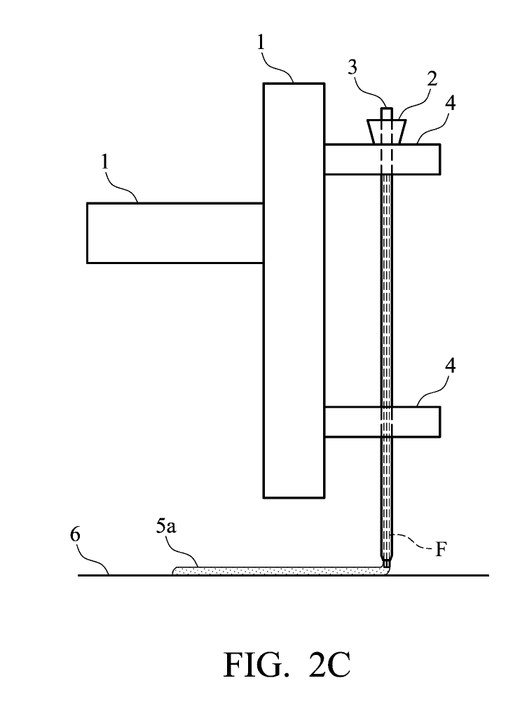

FIGS. 2A to 2C are schematic plane views showing a discontinuous capillary coating device and a discontinuous capillary coating operation thereof. The discontinuous capillary coating device comprises a displacing platform 1, a barricade 2, a capillary tube 3, a plurality of flexible members F, two capillary tube holders 4, and a coating substrate 6. As shown in FIG. 2A, the capillary tube 3 is connected to the barricade 2 and is disposed on the capillary tube holders 4. Here, the capillary tube 3 is filled with a coating material. The flexible members F are disposed in the capillary tube 3 and are immersed in the coating material. Specifically, the flexible members F extend to the exterior of the capillary tube 3, guiding and outputting the coating material. Moreover, the capillary tube 3 comprises a tapered outlet which comprises a polished flat opening, and the capillary tube holders 4 are fixed to the displacing platform 1. Here, the flexible members F extend to the exterior of the capillary tube 3 through the tapered outlet. In this embodiment, the flexible members F may comprise a solid material, a hollow material, or a porous material. Being a solid material, each flexible member F may be a metal wire, a plastic wire, fiber glass, fiber, fur, or feather. Being a hollow material, each flexible member F may be a plastic tube. In another aspect, being a porous material, each flexible member F may be open cell foam (as in a sponge) or fibrous network (as in a marking pen). As shown in FIG. 2B, when the discontinuous capillary coating device contacts the coating substrate 6, upward and downward latitude is properly provided between the capillary tube 3 and the capillary tube holders 4, preventing damage of the capillary tube 3. As shown in FIG. 2C, the discontinuous capillary coating device produces a liquid film 5a, from the coating material, on the coating substrate 6 via the flexible members F.

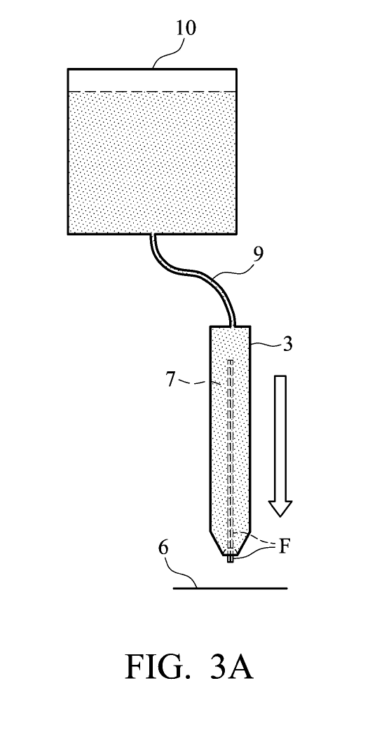

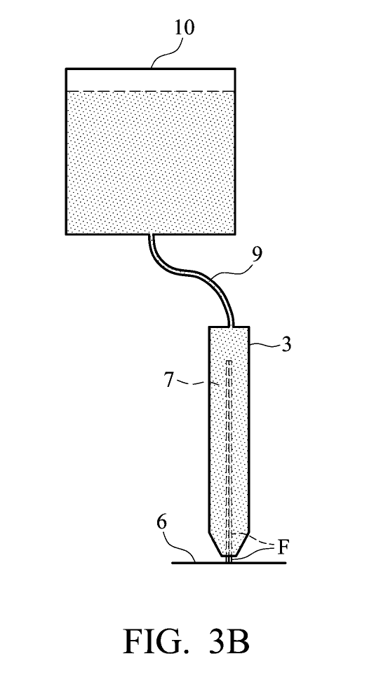

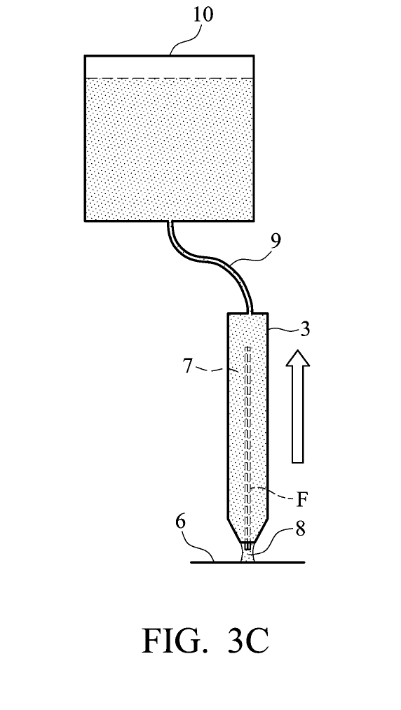

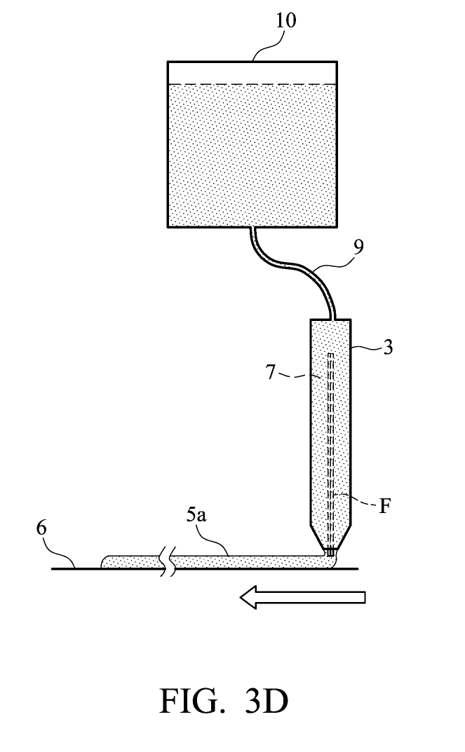

FIGS. 3A to 3D are schematic plane views showing a continuous capillary coating device and a continuous capillary coating operation thereof. The discontinuous capillary coating device comprises a capillary tube 3, a plurality of flexible members F, a connection member 9, a fluid reservoir 10, and a coating substrate 6. The capillary tube 3 is connected to the fluid reservoir 10 through the connection member 9. Here, the fluid reservoir 10 can continuously supply a coating material 7 to the capillary tube 3, such that the capillary tube 3 is filled with the coating material 7. Moreover, the flexible members F are disposed in the capillary tube 3 and are immersed in the coating material 7. Specifically, the flexible members F extend to the exterior of the capillary tube 3, guiding and outputting the coating material 7. Additionally, the capillary tube 3 comprises a tapered outlet which comprises a polished flat opening. Here, the flexible members F extend to the exterior of the capillary tube 3 through the tapered outlet. Similarly, the flexible members F may comprise a solid material, a hollow material, or a porous material. Being a solid material, each flexible member F may be a metal wire, a plastic wire, fiber glass, fiber, fur, or feather. Being a hollow material, each flexible member F may be a plastic tube. In another aspect, being a porous material, each flexible member F may be open cell foam (as in a sponge) or fibrous network (as in a marking pen).

As shown in FIG. 3A, the capillary tube 3 is moved downward. As shown in FIG. 3B, the flexible members F, extending to the exterior of the capillary tube 3, contacts the coating substrate 6, enabling the coating material 7 to adhere to the coating substrate 6. As shown in FIG. 3C, the capillary tube 3 is moved upward to a specific position, connecting the flexible members F (or capillary tube 3) to the coating substrate 6 through a liquid bridge 8. As shown in FIG. 3D, the capillary tube 3 is moved with respect to and parallel to the coating substrate 6, coating the coating material 7 onto the coating substrate 6 via the flexible members F, and further forming a continuously coated liquid film 5a from the coating material 7.

Accordingly, the traversing mechanism drives the capillary tube filled with the coating material to move with respect to the coating substrate. When contacting the coating substrate, the coating material adheres to the coating substrate by a capillary force provided therebetween, thereby performing the coating operation. By controlling relative movement between the capillary tube (or flexible members F) and the coating substrate, various continuous stripe-like liquid films or discontinuous patch-like liquid films can be generated. Furthermore, the patch pattern can be defined by the relative movement between the capillary tube (or flexible members F) and the coating substrate. Specifically, as the coating material is coated onto the coating substrate via the flexible members F, breakage or damage of the capillary tube is effectively prevented even though the coating substrate is uneven or is provided with variable heights, thereby ensuring a good performance of the continuous/discontinuous coating operation. Moreover, the flexible members F can provide edge-guiding functions. Namely, because of the flexible members F, the coating material is smoothly and stably guided onto the coating substrate, such that cutoff of the liquid film can be completely avoided during the continuous/discontinuous coating operation.

Accordingly, by the capillary force provided between the coating material and the coating substrate, the capillary tube filled with the coating material can wet the coating substrate. The coating operation is performed on the coating substrate by movement of the traversing mechanism, coating various discontinuous liquid micro-patches on the coating substrate. For example, during manufacturing of a color filter, patterns with R, G, and B patches can be generated on a coating substrate thereof.

In conclusion, the disclosed devices can solve the problem of low utility rate of the raw materials provided by the spin coating or spraying coating and exposure development methods and can thus be applied to coating of large panels. Moreover, the disclosed techniques can solve the problem of low productivity provided by the ink-jet printing method. Additionally, compared with the stamping method, the disclosed devices can enhance the variability of the pattern. Furthermore, compared with the stripe coating and discontinuous micro-patch coating methods, the disclosed devices can provide reduced manufacturing costs. In summary, as equipment and manufacturing costs are reduced and productivity is enhanced, the disclosed devices or techniques can be applied to the manufacturing of the large panels and designing of complicated micro-structural patterns.

Moreover, the capillary tubes of the disclosed devices directly perform the coating operation. The coated patterns can be determined by the relative movement between the capillaries and the coating substrates. The separated distance between the capillary tubes of the disclosed devices can be freely adjusted, such that the coated patterns can be provided with enhanced variability, as compared with those generated by the conventional stamping and stripe coating methods. Moreover, compared with the conventional ink-jet printing method, the disclosed devices or techniques do not require high positioning precision and can enhance productivity.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A discontinuous capillary coating device, comprising:
at least one capillary tube filled with a coating material;
at least one flexible member disposed in the capillary tube and immersed in the coating material, wherein the flexible member extends to the exterior of the capillary tube, guiding and outputting the coating material;
at least one coating substrate receiving a liquid coating film from the coating material via the flexible member;
at least one capillary tube holder holding the capillary tube, guiding movement of the capillary tube; and
at least one traversing mechanism driving the capillary tube holder or coating substrate to move.

2. The discontinuous capillary coating device as claimed in claim 1, wherein the capillary tube comprises a tapered outlet, and the flexible member extends to the exterior of the capillary tube through the tapered outlet.

3. The discontinuous capillary coating device as claimed in claim 2, wherein the tapered outlet comprises a polished flat opening.

4. The discontinuous capillary coating device as claimed in claim 1, wherein the coating material is capable of wetting the coating substrate.

5. The discontinuous capillary coating device as claimed in claim 1, wherein unidirectional latitude is provided between the capillary tube and the capillary tube holder.

6. The discontinuous capillary coating device as claimed in claim 1, further comprising a barricade disposed on the capillary tube or capillary tube holder, restraining the ultimate moving position of the capillary tube.

7. The discontinuous capillary coating device as claimed in claim 1, wherein the flexible member comprises a solid material, a hollow material, or a porous material.

8. The discontinuous capillary coating device as claimed in claim 7, wherein the solid material comprises a metal wire, a plastic wire, fiber glass, fiber, fur, or feather.

9. The discontinuous capillary coating device as claimed in claim 7, wherein the hollow material comprises a plastic tube.

10. The discontinuous capillary coating device as claimed in claim 7, wherein the porous material comprises open cell foam (as in a sponge) or fibrous network (as in a marking pen).

11. A continuous capillary coating device, comprising:
at least one capillary tube;
at least one fluid reservoir providing a coating material to the capillary tube;
at least one flexible member disposed in the capillary tube and immersed in the coating material, wherein the flexible member extends to the exterior of the capillary tube, guiding and outputting the coating material;
at least one coating substrate receiving a liquid coating film from the coating material via the flexible member;
at least one capillary tube holder holding the capillary tube, guiding movement of the capillary tube; and
at least one traversing mechanism driving the capillary tube holder or coating substrate to move.

12. The continuous capillary coating device as claimed in claim 11, wherein the capillary tube comprises a tapered outlet, and the flexible member extends to the exterior of the capillary tube through the tapered outlet.

13. The continuous capillary coating device as claimed in claim 12, wherein the tapered outlet comprises a polished flat opening.

14. The continuous capillary coating device as claimed in claim 11, wherein the coating material is capable of wetting the coating substrate.

15. The continuous capillary coating device as claimed in claim 11, wherein unidirectional latitude is provided between the capillary tube and the capillary tube holder.

16. The continuous capillary coating device as claimed in claim 11, further comprising a barricade disposed on the capillary tube or capillary tube holder, restraining the ultimate moving position of the capillary tube.

17. The continuous capillary coating device as claimed in claim 11, wherein the flexible member comprises a solid material, a hollow material, or a porous material.

18. The continuous capillary coating device as claimed in claim 17, wherein the solid material comprises a metal wire, a plastic wire, fiber glass, fiber, fur, or feather.

19. The continuous capillary coating device as claimed in claim 17, wherein the hollow material comprises a plastic tube.

20. The continuous capillary coating device as claimed in claim 17, wherein the porous material comprises open cell foam (as in a sponge) or fibrous network (as in a marking pen).
